(19) United States
(12) Patent Application Publication
(10) Pub. No.: US 2026/0202848 A1
(43) Pub. Date: Jul. 16, 2026

(54) Fixed-Time Sliding Mode Control Method and System for Tiltrotor Unmanned Aerial Vehicles with Prescribed Performance

(71) Applicant: Guangdong University of Technology, Guangzhou (CN)

(72) Inventors: Panshuo LI, Guangzhou (CN); Liwei LUO, Guangzhou (CN); LI YUAN, Guangzhou (CN); Renquan LU, Guangzhou (CN); Qianqian CAI, Guangzhou (CN)

(73) Assignee: Guangdong University of Technology, Guangzhou (CN)

(21) Appl. No.: 19/412,901

(22) Filed: Dec. 9, 2025

(30) Foreign Application Priority Data
Jan. 10, 2025 (CN) 202510039562 .5

(51) Int. Cl. G05D 1/495; G05D 109/22

(52) U.S. Cl. CPC G05D 1/495; G05D 2109/24

(57) ABSTRACT

The present invention relates to the technical field of unmanned aerial vehicle flight control, and proposes a fixed-time sliding mode control method and system for tiltrotor unmanned aerial vehicles with prescribed performance. The method includes: constructing the motion model of the tiltrotor unmanned aerial vehicle; constructing a transformed error based on a prescribed performance function; designing a fixed-time nonsingular terminal sliding mode surface combined with adaptive gain; combining the control model with the nonsingular terminal sliding mode surface based on the motion model to construct a control law, and controlling the tiltrotor unmanned aerial vehicle based on the control law. The present invention solves the singularity problem existing in the prior art and accelerates the convergence speed.

### FIELD OF INVENTION

The present invention relates to the technical field of unmanned aerial vehicle control, and in particular to a fixed-time sliding mode control method and system for a tiltrotor unmanned aerial vehicle with preset performance.

### BACKGROUND OF THE INVENTION

As a variable-structure hybrid vertical takeoff and landing unmanned aerial vehicles, tiltrotor unmanned aerial vehicles employ tilting servos to alter the thrust rotor orientation, enabling flight mode switching between multirotor and fixed-wing flight modes. This hybrid design not only provides vertical take-off and landing capability but also ensures efficient high-speed cruise performance. Due to their advantages, including runway-independent operation, strong payload capacity, and long endurance, tiltrotor unmanned aerial vehicles show broad application potential in fields such as terrain reconnaissance, emergency rescue, logistics delivery, and agricultural plant protection. However, the unique airframe structure of tiltrotor unmanned aerial vehicles introduces multiple modes, strongly nonlinear dynamics, and significant aerodynamic interference. These characteristics pose substantial challenges for flight control, particularly during mode transition. Therefore, designing a fast, robust, and high-performance-guaranteed flight controller is particularly important for tiltrotor unmanned aerial vehicles. Several prior arts have been investigated for tiltrotor unmanned aerial vehicle flight control. For instance, model predictive control has been applied, but it suffers from high computational load, slow response, and strong dependence on model accuracy. Fuzzy active disturbance rejection control has also been adopted, which exhibits good robustness but relatively slow convergence, limiting its practical applicability. Another direction involves neural network-based adaptive sliding mode control, which offers simple structure and fast response; however, the tracking error only achieves finite-time convergence with dependence on initial errors. Moreover, prescribed performance robust control methods have been proposed to guarantee both steady-state and transient performance, but their performance boundary follow exponential convergence—resulting in slow convergence rates—and impose restrictions on initial errors, thus failing to achieve global prescribed performance control.

### SUMMARY OF THE INVENTION

The present invention designed a fixed-time sliding mode control method and system for tiltrotor unmanned aerial vehicles with prescribed performance. The designed sliding mode surface-based control law enables system convergence within a fixed time, which is more suitable for the requirements of unmanned aerial vehicle systems with rapidly changing flight states compared to traditional exponential convergence and finite-time convergence. Specifically, by designing a nonsingular sliding mode surface, the singularity problem existing in traditional fixed-time sliding mode control is overcome, eliminating the need for additional auxiliary functions and simplifying the controller structure. In addition, the adopted prescribed performance function can ensure that the unmanned aerial vehicle reaches the steady-state range within a fixed time, realizing global prescribed performance control. By organically combining the sliding mode surface with the prescribed performance control strategy, an efficient and accurate flight control solution is provided for tiltrotor unmanned aerial vehicles.

### BRIEF DESCRIPTION OF DRAWINGS

FIG. 1 shows a flowchart of the prescribed performance-based fixed-time sliding mode control method for the tiltrotor unmanned aerial vehicle according to Embodiment 1 of the present application;

FIG. 2 shows the architecture of the prescribed performance-based fixed-time sliding mode control system for the tiltrotor unmanned aerial vehicle according to Embodiment 2 of the present application;

FIG. 3 shows the position control curve of the tilt-rotor UAV during a process of a simulation control;

FIG. 4 shows the tracking error curve of the tilt-rotor UAV during a process of the simulation control;

FIG. 5 shows the attitude angle control curve of the tilt-rotor UAV during a process of the simulation control; and

FIG. 6 shows the attitude angle tracking error curve of the tilt-rotor UAV during the process of the simulation control.

### DETAILED DESCRIPTION OF THE INVENTION

An object of the present invention is to disclose a fixed-time sliding mode control system for tiltrotor unmanned aerial vehicles with prescribed performance, which has faster convergence rate.

### Embodiment I

Referring to FIG. 1, in order to realize the above purpose, the present invention provides a fixed-time sliding mode control system for tiltrotor unmanned aerial vehicles with prescribed performance, comprising:
S1: Constructing the motion model of the tiltrotor unmanned aerial vehicle;
S2: Constructing the transformed error based on the prescribed performance function;
S3: Designing the fixed-time nonsingular terminal sliding mode surface combined with adaptive gain;
S4: Based on the motion model, the control model is combined with the nonsingular terminal sliding mode surface to construct a control law, and the tiltrotor unmanned aerial vehicle is controlled based on the control law.

The present invention also proposes a fixed-time sliding mode control system for tiltrotor unmanned aerial vehicles with prescribed performance, comprising:
A control law solving module: It carries the motion model of the tiltrotor unmanned aerial vehicle, the control model based on prescribed performance, and the nonsingular terminal sliding mode surface; based on the motion model, it combines the control model with the nonsingular terminal sliding mode surface and obtains the control law;
A tiltrotor unmanned aerial vehicle control module: It controls the tiltrotor unmanned aerial vehicle based on the control law.

In step S1, constructing the mathematical model of the tiltrotor unmanned aerial vehicle, comprises: first, construct the position loop model and attitude loop model of the unmanned aerial vehicle; then, obtain the six-degree-of-freedom motion equation based on the position loop model and attitude loop model.

The process of constructing the position loop model of the unmanned aerial vehicle includes: correlating the velocity in the body coordinate system with the position in the ground coordinate system through a transformation matrix, modeling the velocity and acceleration of the unmanned aerial vehicle, and modeling the rotor thrust, aerodynamic force, and gravity in the acceleration to obtain the position loop model of the unmanned aerial vehicle, whose expression is as follows:

$$\dot{P} = [ \begin{matrix}{\dot{x}}_{e} \\ {\dot{y}}_{e} \\ \dot{H}\end{matrix} ] = v = [ \begin{matrix}{v}_{x} \\ {v}_{y} \\ {v}_{z}\end{matrix} ] = {R}_{b}^{e} [ \begin{matrix}u \\ v \\ w\end{matrix} ]$$

$$\ddot{P} = \dot{v} = \frac{1}{m} ( {F}_{p} + {F}_{a} + {F}_{g} ) + {d}_{F}$$

$${F}_{p} = {\sum }_{i = 1}^{4} {R}_{b}^{e} {R}_{ri}^{b} {T}_{i} = {R}_{b}^{e} [ \begin{matrix}{T}_{1} cos Φ + {T}_{3} sin Φ \\ 0 \\ - {T}_{1} cos Φ - {T}_{2} - {T}_{3} sin Φ - {T}_{4}\end{matrix} ]$$

$${F}_{a} = [ \begin{matrix}- D \\ Y \\ - L\end{matrix} ] = \overline{q} S [ \begin{matrix}- {C}_{D} \\ {C}_{Y} \\ - {C}_{L}\end{matrix} ]$$

$${F}_{g} = [ \begin{matrix}0 \\ 0 \\ 1\end{matrix} ] mg$$

Where P=[xₑ, yₑ, H]^{T} is the position vector of the tiltrotor unmanned aerial vehicle in the ground frame; v=[vₓ, v_{y}, v_{z}] is the velocity vector of the tiltrotor unmanned aerial vehicle in the ground frame; R_{b}^{e} is the transformation matrix from the body frame to the ground frame, [u, v, w] is the velocity vector of the tiltrotor unmanned aerial vehicle in the body frame; \dot{v} is the acceleration; m is the mass of the tiltrotor unmanned aerial vehicle, d_{F} is the total disturbance of the position loop, Fₚ is the force generated by the rotors, Fₐ is the aerodynamic force generated by the wings and fuselage, F_{g} is the gravity of the tiltrotor unmanned aerial vehicle;

$${R}_{ri}^{b}$$

is the transformation matrix from the rotor frame to the body coordinate system, Tᵢ (i=1, 2, 3, 4) is the thrust generated by each rotor, [D, Y, L]^{T} are the drag force, side force, and lift force acting on the tiltrotor unmanned aerial vehicle respectively;

$$\overline{q} = 1 / 2 σ {V}_{a}^{2}$$

is the dynamic pressure, σ is the air density, [C_{D}, C_{Y}, C_{L}]^{T} are the drag coefficient, side force coefficient, and lift coefficient respectively; S is the projected area of the tiltrotor unmanned aerial vehicle, g is the gravitational acceleration; Φ is the rotor tilt angle;

Further, in step S1, the process of constructing the attitude loop model of the unmanned aerial vehicle includes: correlating the attitude angular velocity of the tiltrotor unmanned aerial vehicle with the differential of the attitude angle through a transformation matrix, and constructing the attitude angle dynamic equation; decomposing the total torque of the tiltrotor unmanned aerial vehicle, modeling the torque generated by the rotors and the aerodynamic torque of the wings or fuselage, and obtaining the attitude loop model of the unmanned aerial vehicle, whose expression is as follows:

$$\dot{Ω} = [ \begin{matrix}\dot{ϕ} \\ \dot{θ} \\ \dot{ψ}\end{matrix} ] = [ \begin{matrix}1 & sin ϕtan θ & cos ϕtan θ \\ 0 & cos ϕ & - sin ϕ \\ 0 & sin ϕ / cos θ & cos ϕ / cos θ\end{matrix} ] [ \begin{matrix}p \\ q \\ r\end{matrix} ] = {R}_{w}^{Ω} ω$$

$${M}_{p} = [ \begin{matrix}{lT}_{1} cos Φ - {lT}_{2} - {lT}_{3} cos Φ + {lT}_{4} + {τ}_{1} sin Φ - {τ}_{3} sin Φ \\ - {lT}_{1} cos Φ + {lT}_{2} - {lT}_{3} cos Φ + {lT}_{4} \\ {lT}_{1} sin Φ - {lT}_{3} sin Φ + - {τ}_{1} sin Φ - {τ}_{2} + {τ}_{3} cos Φ + {τ}_{4}\end{matrix} ]$$

$${M}_{a} = \overline{q} S [ \begin{matrix}{l}_{w} {C}_{l} \\ \overline{c} {C}_{m} \\ {l}_{w} {C}_{n}\end{matrix} ]$$

$$\ddot{Ω} = \dot{ω} = - {I}^{- 1} ω \times I ω + {I}^{- 1} M + {d}_{M}$$

Where, Ω=[φ, θ, ψ]^{T} is the attitude angle of the tiltrotor unmanned aerial vehicle; ω=[p, q, r]^{T} is the attitude angular velocity;

$${R}_{w}^{Ω}$$

is the transformation matrix from the attitude angular velocity to the differential of the attitude angle; l is the distance between the rotors;

$${τ}_{i} = {k}_{P} {Ω}_{i}^{2} ( i = 1 , 2 , 3 , 4 )$$

is the reaction generated by the rotors; k_{P} is the reaction coefficient of the rotors; Ωᵢ is the rotational speed of each rotor; l_{w} is the wingspan of the tiltrotor unmanned aerial vehicle; c̅ is the mean aerodynamic chord; [Cₗ, Cₘ, Cₙ]^{T} are the roll moment, pitch moment, and yaw moment respectively; Φ is the rotor tilt angle; I=[Iₓ, I_{y}, I_{z}]^{T} is the moment of inertia; d_{M} is the total disturbance of the attitude loop.

In step S2, obtaining the transformed error based on the prescribe performance function comprising: first, design the tracking error performance boundary based on the prescribed performance function; then, design an error transformation function to map the tracking error constrained by the prescribed performance function into a new unconstrained transformation error; finally, construct the control model based on the unconstrained transformation error.

The expression of the error transformation function Ψ(ε) is designed as:

$$Ψ ( ε ) = \frac{{γ}_{2} exp ( ε ) - {γ}_{1} exp ( - ε )}{exp ( ε ) + exp ( - ε )}$$

$${γ}_{1} = \frac{1}{2} ( δ - 1 ) sign ( e ( 0 ) ) + \frac{1}{2} ( δ + 1 )$$

$${γ}_{2} = \frac{1}{2} ( 1 - δ ) sign ( e ( 0 ) ) + \frac{1}{2} ( δ + 1 )$$

Where sign(⋅) is the signum function, 0<δ≤1, e(0) is the initial tracking error, ε is the transformed error; specifically, the tracking error of the control model is defined as e=x−x_{d}, where x is the current state of the unmanned aerial vehicle and x_{d} is the desired state; and a fixed-time prescribed performance function is designed as follows:

$$ρ ( t ) = \{ \begin{matrix}( {ρ}_{0} - \frac{t}{{T}_{f}} ) {e}^{( 1 - \frac{{T}_{f}}{{T}_{f} - t} )} + {ρ}_{∞} & , t ∈ [ 0 , {T}_{f} ) \\ {ρ}_{∞} & , t ∈ [ {T}_{f} , + ∞ )\end{matrix}$$

Where ρₒ is the initial value of the prescribed performance function, ρ_{∞}>0 is the steady-state value, and ρ₀>ρ_{∞}. T_{f} is prescribed maximum allowable convergence time;

To meet the desired performance requirements, an asymmetric tracking error boundary is designed as follow:

$$- {γ}_{1} ρ ( t ) < e ( i ) < {γ}_{2} ρ ( t )$$

In conventional prescribed performance control scheme, the tracking error must satisfy that the initial tracking error is within the initial boundary of the prescribed performance function, that is, −γ₁ρ(0)<e(0)<γ₂ρ(0). To relax this constraint, an improved error transformation function is defined as:

$$c = {γ}_{3} tanh ( ϑ \frac{e ( t )}{ρ ( t )} ) = Ψ ( ε ) = \frac{{γ}_{2} exp ( ε ) - {γ}_{1} exp ( - ε )}{exp ( ε ) + exp ( - ε )}$$

Where ϑ>1, and the expression of γ₃ is defined as:

$${γ}_{3} = \{ \begin{matrix}{γ}_{2} , & e ( t ) \geq 0 \\ {γ}_{1} , & e ( t ) < 0\end{matrix}$$

By taking the inverse function of the error transformation function, a new unconstrained transformed error is obtained as:

$$ε = {Ψ}^{- 1} ( c ) = \frac{1}{2} ln \frac{{γ}_{1} + c}{{γ}_{2} - c}$$

To avoid the equilibrium point offset problem caused by the asymmetric transformation boundary, the error transformation is further designed as:

$$ε = \frac{1}{2} ln \frac{{γ}_{1} + c}{{γ}_{2} - c} - \frac{1}{2} ln \frac{{γ}_{1}}{{γ}_{2}}$$

To facilitate the subsequent controller design, the relationship between the derivative of the error transformation and the original error is derived as:

$$\{ \begin{matrix}\dot{ε} = \frac{1}{2} \dot{c} B \\ \begin{matrix}\ddot{ε} = \frac{{\dot{c}}^{2}}{2} ( \frac{- 1}{{( {γ}_{1} + c )}^{2}} + \frac{1}{{( {γ}_{2} - c )}^{2}} ) - \frac{1}{2} BD - \\ \frac{1 - {tanh}^{2} ( λ )}{2} {γ}_{3} BC + \frac{1 - {tanh}^{2} ( λ )}{2 ρ} {γ}_{3} ϑ B \ddot{e}\end{matrix}\end{matrix}$$

Where B

$$B = \frac{1}{{γ}_{1} + c} + \frac{1}{{γ}_{2} - c} , C = ϑ ( \frac{e \ddot{ρ}}{{ρ}^{2}} + 2 \dot{p} \frac{\dot{e} ρ - e \dot{ρ}}{{ρ}^{3}} ) ,$$

$$λ = ϑ \frac{e}{ρ} , D = 2 {γ}_{3} ( tanh ( λ ) - {tanh}^{3} ( λ ) ) {\dot{λ}}^{2} ;$$

The expression of \ddot{ε} is abbreviated as:

Where

$$\ddot{ε} = E + G \ddot{e}$$

$$E = \frac{{\dot{c}}^{2}}{2} ( \frac{- 1}{{( {γ}_{1} + c )}^{2}} - \frac{1}{{( {γ}_{2} - c )}^{2}} ) - \frac{1}{2} BD - \frac{1 - {tanh}^{2} ( λ )}{2} {γ}_{3} BC ,$$

$$G = \frac{1 - {tanh}^{2} ( λ )}{2 ρ} {γ}_{3} ϑ B .$$

In step 3, the design of the fixed-time sliding mode surface combined with adaptive gain includes: defining a fixed-time sliding mode surface that includes control parameters and state variables; introducing a nonsingular terminal sliding mode function, and incorporating adaptive gain control into the derivative of the sliding mode surface to obtain the nonsingular terminal sliding mode surface.

The expression of the sliding mode surface s is as follows:

$$s = ε + {k}_{1} {sig}^{{α}_{1}} ( ε ) + {k}_{2} {sig}^{{α}_{2}} ( \dot{ε} )$$

$$\{ \begin{matrix}{α}_{1} = \frac{1}{2} + \frac{{σ}_{1}}{2} + sign ( 1 - \vert x \vert ) ( \frac{1}{2} - \frac{{σ}_{1}}{2} ) \\ {α}_{2} = {σ}_{2}^{sign ( 1 - \vert x \vert )}\end{matrix}$$

Where sig^{y}(x)=|x|^{y} sign(x), σ₁>1 and 1<σ₂<2

The expression of the derivative of sliding mode surface is as follows:

$$\dot{s} = - {\hat{l}}_{1} sign ( s ) - {l}_{2} {sign}^{{β}_{1}} ( s ) - {l}_{3} {sign}^{{β}_{2}} ( s )$$

$${\dot{\hat{l}}}_{1} = {ϑ}_{1} \vert s \vert - {ϑ}_{2} {\hat{l}}_{1}$$

Where \hat{l}₁ is an adaptive control gain, l₂>0, l₃>0,

$${β}_{1} = {n}_{1}^{sign ( \vert s \vert - 1 )} , {β}_{2} = {n}_{2}^{sign ( 1 - \vert s \vert )} ,$$

n₁>1, 0<n₂<1, ϑ₁>0 and ϑ₂>0.

Further, in step S4, the process of constructing the control law includes: first, introducing the unconstrained error into the fixed-time sliding mode surface; then, based on the unconstrained error and combined with the position loop and attitude loop models, respectively constructing control expressions for the position tracking error and attitude tracking error to obtain the control law.

Specifically, according to the designed fixed-time nonsingular terminal sliding mode surface and control model, the new sliding mode surface is obtained as follows:

$$s = ε + {k}_{1} {sig}^{{α}_{1}} ( ε ) + {k}_{2} {sig}^{{α}_{2}} ( \dot{ε} )$$

By taking the derivative of both sides of the above equation and combining it with the designed derivative of the sliding mode surface, it can be obtained:

$$\ddot{ε} = - \frac{1}{{k}_{2} {α}_{2}} {\dot{ε}}^{1 - {a}_{1}} ( \dot{ε} + {k}_{1} {α}_{1} {\vert ε \vert}^{{α}_{1} - 1} \dot{ε} + {\hat{l}}_{1} sign ( s ) + {l}_{2} {sig}^{{β}_{1}} ( s ) + {l}_{3} {sig}^{{β}_{2}} ( s ) )$$

From the relationship between the original error and the transformed error, combined with the position loop model of the tiltrotor unmanned aerial vehicle, it can be obtained:

$$\ddot{ε} = E + G {\ddot{e}}_{P} = E + G ( {m}^{- 1} {u}_{P} + {d}_{F} - {\ddot{P}}_{d} )$$

Where e_{P}=P−P_{d} is the position tracking error, P is the current position, P_{d} is the desired position, then, the expression of the control law for the position loop, denoted as u_{P}, can be obtained as follows:

$${u}_{P} = m ( {\ddot{P}}_{d} - \frac{1}{{k}_{P 2} {a}_{P 2} G} {\dot{ε}}^{1 - {a}_{P 1}} ( \text{} \dot{ε} + {k}_{P 1} {a}_{P 1} {\vert ε \vert}^{{a}_{P 1} - 1} \dot{ε} + {\hat{l}}_{P 1} sign ( s ) + {l}_{P 2} {sig}^{{β}_{P 1}} ( s ) + {l}_{P 3} {sig}^{{β}_{P 2}} ( s ) ) - \frac{E}{G} - {d}_{F} )$$

Where the subscripts P1, P2, and P3 indicate that the parameters are those of the position loop controller;

Similarly, the relationship between the original error and the transformed error of the attitude loop of the tiltrotor unmanned aerial vehicle can be obtained as follows:

$${u}_{Ω} = I ( {I}^{- 1} ω \times I ω + {\ddot{Ω}}_{d} - \frac{1}{{k}_{Ω 2} {a}_{Ω 2} G} {\dot{ε}}^{1 - {a}_{Ω 1}} ( \text{} \dot{ε} + {k}_{Ω 1} {a}_{Ω 1} {\vert ε \vert}^{{a}_{Ω 1} - 1} \dot{ε} + {\hat{l}}_{Ω1} sign ( s ) + {l}_{Ω 2} {sig}^{{β}_{Ω 1}} ( s ) + {l}_{3} {sig}^{{β}_{Ω 2}} ( s ) ) - \frac{E}{G} - {d}_{M} )$$

Where the subscripts Ω1, Ω2, and Ω3 indicate that the parameters are those of the attitude loop controller.

The beneficial effects of the technical solution from the present invention compared to the prior art are as below:

The present invention designed a fixed-time sliding mode control method and system for tiltrotor unmanned aerial vehicles with prescribed performance. The designed sliding mode surface-based control law enables system convergence within a fixed time, which is more suitable for the requirements of unmanned aerial vehicle systems with rapidly changing flight states compared to traditional exponential convergence and finite-time convergence. Specifically, by designing a nonsingular sliding mode surface, the method address the singularity problem existing in conventional fixed-time sliding mode control, eliminating the need for additional auxiliary functions and simplifying the controller structure. In addition, the adopted prescribed performance function can ensure that the unmanned aerial vehicle reaches the steady-state range within a fixed time, realizing global prescribed performance control. By combining the sliding mode surface with the prescribed performance control strategy, an efficient and accurate flight control scheme is provided for tiltrotor unmanned aerial vehicles.

The beneficial effects of the technical solution from the present invention compared to the prior art are as below:

### Application Instances

The drawings are attached to exemplary illustration only and are not to be construed as a limitation of this patent.

The technical solution of the present invention is further described below in connection with the accompanying drawings and embodiments.

### Embodiment 1

This embodiment discloses, as shown in FIG. 1, a fixed-time sliding mode control system for tiltrotor unmanned aerial vehicles with prescribed performance, comprising the following steps:
S1: Constructing the motion model of the tiltrotor unmanned aerial vehicle;
S2: Constructing the transformed error based on the prescribed performance function;
S3: Designing the fixed-time nonsingular terminal sliding mode surface combined with adaptive gain;
S4: Based on the motion model, the control model is combined with the nonsingular terminal sliding mode surface to construct a control law, and the tiltrotor unmanned aerial vehicle is controlled based on the control law.

The embodiment enhances the flight control performance of the tiltrotor unmanned aerial vehicle by the strategy that combining sliding mode control and prescribed performance control method. Specifically, the designed control method achieves convergence within a fixed time, making it more adaptive to rapidly changing flight states of unmanned aerial vehicles compared to traditional exponential or finite-time convergence methods. Moreover, by constructing a nonsingular sliding surface, common singularity issues are completely eliminated without introducing complex auxiliary functions, thereby significantly simplifying the control algorithm. The combination of the high responsiveness of sliding mode control and the transient performance guarantee of prescribed performance control results in a fast, accurate, and stable flight control method for tiltrotor unmanned aerial vehicle systems, substantially improving their adaptability and reliability under complex flight conditions.

In step S1, the step of constructing the mathematical model for the tiltrotor unmanned aerial vehicle comprises: first, construct the position loop model and attitude loop model of the unmanned aerial vehicle; then, obtain the six-degree-of-freedom motion equation based on the position loop model and attitude loop model.

In this embodiment, by dividing the motion model into a position loop model and an attitude loop model for construction, the translational motion and rotational motion characteristics of the unmanned aerial vehicle are effectively separated. This makes the kinematic and dynamic analysis clearer and more intuitive, thereby improving the modeling accuracy of the unmanned aerial vehicle control model.

Further, in step S1, the process of constructing the position loop model of the unmanned aerial vehicle includes: correlating the velocity in the body coordinate system with the position in the ground coordinate system through a transformation matrix, modeling the velocity and acceleration of the unmanned aerial vehicle, and modeling the rotor thrust, aerodynamic force, and gravity in the acceleration to obtain the position loop model of the unmanned aerial vehicle, the expression is as follows:

$$\dot{P} = [ \begin{matrix}\begin{matrix}{\dot{x}}_{e} \\ {\dot{y}}_{e}\end{matrix} \\ \dot{H}\end{matrix} ] = ν = [ \begin{matrix}{v}_{x} \\ {v}_{y} \\ {v}_{z}\end{matrix} ] = {R}_{b}^{e} [ \begin{matrix}u \\ v \\ w\end{matrix} ]$$

$$\ddot{P} = \dot{ν} = \frac{1}{m} ( {F}_{p} + {F}_{a} + {F}_{g} ) + {d}_{F}$$

$${F}_{p} = {\sum }_{i = 1}^{4} {R}_{b}^{e} {R}_{ri}^{b} {T}_{i} = {R}_{b}^{e} [ \begin{matrix}\begin{matrix}{T}_{1} sin Φ + {T}_{3} sin Φ \\ 0\end{matrix} \\ - {T}_{1} cos Φ - {T}_{2} - {T}_{3} cos Φ - {T}_{4}\end{matrix} ]$$

$${F}_{a} = [ \begin{matrix}- D \\ Y \\ - L\end{matrix} ] = \overline{q} S [ \begin{matrix}- {C}_{D} \\ {C}_{Y} \\ - {C}_{L}\end{matrix} ]$$

$${F}_{g} = [ \begin{matrix}0 \\ 0 \\ 1\end{matrix} ] mg$$

Where P=[xₑ, yₑ, H]^{T} is the position vector of the tiltrotor unmanned aerial vehicle in the ground frame; v=[vₓ, v_{y}, v_{z}] is the velocity vector of the tiltrotor unmanned aerial vehicle in the ground frame;

$${R}_{b}^{e}$$

is the transformation matrix from the body frame to the ground frame, [u, v, w] is the velocity vector of the tiltrotor unmanned aerial vehicle in the body frame; \dot{v} is the acceleration; m is the mass of the tiltrotor unmanned aerial vehicle, d_{F} is the total disturbance of the position loop, Fₚ is the force generated by the rotors, Fₐ is the aerodynamic force generated by the wings and fuselage, F_{g} is the gravity of the tiltrotor unmanned aerial vehicle;

$${R}_{ri}^{b}$$

is the transformation matrix from the rotor frame to the body coordinate system, Tᵢ (i=1, 2, 3, 4) is the thrust generated by each rotor, [D, Y, L]^{T} are the drag force, side force, and lift force acting on the tiltrotor unmanned aerial vehicle respectively; q̅=½σVₐ² is the dynamic pressure, σ is the air density, [C_{D}, C_{Y}, C_{L}]^{T} are the drag coefficient, side force coefficient, and lift coefficient respectively; S is the projected area of the tiltrotor unmanned aerial vehicle, g is the gravitational acceleration; Φ is the rotor tilt angle;

In this embodiment, by using a transformation matrix to correlate the velocity in the body coordinate system with the position in the ground coordinate system and accurately modeling the velocity and acceleration, the accurate description and analysis of the unmanned aerial vehicle's motion state in three-dimensional space can be achieved. Furthermore, key forces such as rotor thrust, aerodynamic force, and gravity in the acceleration are modeled, ensuring that the model can fully reflect the unmanned aerial vehicle's actual force-bearing conditions and motion characteristics. The position loop model accurately describes the law of the unmanned aerial vehicle's position change, providing a detailed and reliable reference for the design of subsequent control algorithms.

Further, in step S1, the process of constructing the attitude loop model of the unmanned aerial vehicle includes: correlating the attitude angular velocity of the tiltrotor unmanned aerial vehicle with the differential of the attitude angle through a transformation matrix, and constructing the attitude angle dynamic equation; decomposing the total torque of the tiltrotor unmanned aerial vehicle, modeling the torque generated by the rotors and the aerodynamic torque of the wings or fuselage, and obtaining the attitude loop model of the unmanned aerial vehicle, whose expression is as follows:

$$\dot{Ω} = [ \begin{matrix}\dot{ϕ} \\ \dot{θ} \\ \dot{ψ}\end{matrix} ] = [ \begin{matrix}1 & sin ϕtan θ & cos ϕtanθ \\ 0 & cos ϕ & - sin ϕ \\ 0 & sin ϕ / cos θ & cos ϕ / cos θ\end{matrix} ] [ \begin{matrix}p \\ q \\ r\end{matrix} ] = {R}_{w}^{Ω} ω$$

$${M}_{p} = [ \begin{matrix}{lT}_{1} cos Φ & - {lT}_{2} - {lT}_{3} cos Φ + {lT}_{4} + {τ}_{1} sin Φ - {τ}_{3} sin Φ \\ & - {lT}_{1} cos Φ + {lT}_{2} - {lT}_{3} cosΦ + {lT}_{4} \\ {lT}_{1} sin Φ & - {lT}_{3} sin Φ + - {τ}_{1} sin Φ - {τ}_{2} + {τ}_{3} cos Φ + {τ}_{4}\end{matrix} ]$$

$${M}_{a} = \overline{q} S [ \begin{matrix}{l}_{w} {C}_{l} \\ \overline{c} {C}_{m} \\ {l}_{w} {C}_{n}\end{matrix} ]$$

$$\ddot{Ω} = \dot{ω} = - {I}^{- 1} ω \times I ω + {I}^{- 1} M + {d}_{M}$$

Where, Ω=[φ, θ, ψ]^{T} is the attitude angle of the tiltrotor unmanned aerial vehicle; ω=[p, q, r]^{T} is the attitude angular velocity;

$${R}_{w}^{Ω}$$

is the transformation matrix from the attitude angular velocity to the differential of the attitude angle; l is the distance between the rotors;

$${τ}_{i} = {k}_{P} {Ω}_{i}^{2} ( i = 1 , 2 , 3 , 4 )$$

is the reaction generated by the rotors; k_{P} is the reaction coefficient of the rotors; Ωᵢ is the rotational speed of each rotor; l_{w} is the wingspan of the tiltrotor unmanned aerial vehicle; c̅ is the mean aerodynamic chord; [Cₗ, Cₘ, Cₙ]^{T} are the roll moment, pitch moment, and yaw moment respectively; Φ is the rotor tilt angle; I=[Iₓ, I_{y}, I_{z}]^{T} is the moment of inertia; d_{M} is the total disturbance of the attitude loop.

In this embodiment, by using a transformation matrix to correlate the attitude angular velocity of the tiltrotor unmanned aerial vehicle with the differential of the attitude angle and constructing the dynamic equation of the attitude angle, the accurate description of the law of the unmanned aerial vehicle's attitude change is achieved. Through the decomposition of the total torque and the detailed modeling of the torque generated by the rotors and the aerodynamic torque of the wings or fuselage, the model can fully reflect the torque distribution and dynamic characteristics in the unmanned aerial vehicle's attitude control, improving the analytical capability for the unmanned aerial vehicle's attitude change process. Meanwhile, the refined modeling of different torques ensures the physical authenticity and calculation accuracy of the attitude loop model, enabling the model to accurately reflect the attitude response characteristics of the tiltrotor unmanned aerial vehicle in complex flight environments.

In step S2, obtaining the transformed error based on the prescribe performance function comprising: first, design the tracking error performance boundary based on the prescribed performance function; then, design an error transformation function to map the tracking error constrained by the prescribed performance function into a new unconstrained transformation error; finally, construct the control model based on the unconstrained transformation error.

The expression of the error transformation function F(E) is designed as:

$$Ψ ( ε ) = \frac{{γ}_{2} exp ( ε ) - {γ}_{1} exp ( - ε )}{exp ( ε ) + exp ( - ε )}$$

$${γ}_{1} = \frac{1}{2} ( δ - 1 ) sign ( e ( 0 ) ) + \frac{1}{2} ( δ + 1 )$$

$${γ}_{2} = \frac{1}{2} ( 1 - δ ) sign ( e ( 0 ) ) + \frac{1}{2} ( δ + 1 )$$

Where sign(⋅) is the signum function, 0<δ≤1, e(0) is the initial tracking error, ε is the transformed error; specifically, the tracking error of the control model is defined as e=x−x_{d}, where x is the current state of the unmanned aerial vehicle and x_{d} is the desired state; and a fixed-time prescribed performance function is designed as follows:

$$ρ ( t ) = \{ \begin{matrix}( {ρ}_{0} - \frac{t}{{T}_{f}} ) {e}^{( 1 - \frac{{T}_{f}}{{T}_{f} - t} )} + {ρ}_{∞} , & t ∈ [ 0 , {T}_{f} ) \\ {ρ}_{∞} , & t ∈ [ {T}_{f} , + ∞ )\end{matrix}$$

Where ρ₀ is the initial value of the prescribed performance function, ρ_{∞}>0 is the steady-state value, and ρ₀>ρ_{∞}, T_{f} is prescribed maximum allowable convergence time;

To meet the desired performance requirements, an asymmetric tracking error boundary is designed as follow:

$$- {γ}_{1} ρ ( t ) < e ( t ) < {γ}_{2} ρ ( t )$$

In conventional prescribed performance control scheme, the tracking error must satisfy that the initial tracking error is within the initial boundary of the prescribed performance function, that is, −γ₁ρ(0)<e(0)<γ₂ρ(0). To relax this constraint, an improved error transformation function is defined as:

$$c = {γ}_{3} tanh ( ϑ \frac{e ( t )}{ρ ( t )} ) = Ψ ( ε ) = \frac{{γ}_{2} exp ( ε ) - {γ}_{1} exp ( - ε )}{exp ( ε ) + exp ( - ε )}$$

Where ϑ>1, and the expression of γ₃ is defined as:

$${γ}_{3} = \{ \begin{matrix}{γ}_{2} , & e ( t ) \geq 0 \\ {γ}_{1} , & e ( t ) < 0\end{matrix}$$

By taking the inverse function of the error transformation function, a new unconstrained transformed error is obtained as:

$$ε = {Ψ}^{- 1} ( c ) = \frac{1}{2} ln \frac{{γ}_{1} + c}{{γ}_{2} - c}$$

As can be seen from the above equation, when the new transformed error ε, instead of the original error e(t), is used to establish the controller, when the original error e(t) approaches the prescribed performance boundary, the value of the transformed error c will increase rapidly. This generates a large control input, forcing e(t) to return within the prescribed performance boundary. Through the error transformation process, the system originally controlled by the constrained original error is equivalently converted to one controlled by the unconstrained error, fulfilling the requirement of prescribed performance control.

To avoid the equilibrium point offset problem caused by the asymmetric transformation boundary, the error transformation is further designed as:

$$ε = \frac{1}{2} ln \frac{{γ}_{1} + c}{{γ}_{2} - c} - \frac{1}{2} ln \frac{{γ}_{1}}{{γ}_{2}}$$

To facilitate the subsequent controller design, the relationship between the derivative of the error transformation and the original error is derived as:

$$\{ \begin{matrix}\dot{ε} = \frac{1}{2} \dot{c} B \\ \begin{matrix}\ddot{ε} = \frac{{\dot{c}}^{2}}{2} ( \frac{- 1}{{( {γ}_{1} + c )}^{2}} + \frac{1}{{( {γ}_{2} - c )}^{2}} ) - \frac{1}{2} BD - \\ \frac{1 - {tanh}^{2} ( λ )}{2} {γ}_{3} BC + \frac{1 - {tanh}^{2} ( λ )}{2 ρ} {γ}_{3} ϑ B \ddot{e}\end{matrix}\end{matrix}$$

Where

$$B = \frac{1}{{γ}_{1} + c} + \frac{1}{{γ}_{2} - c} , C = ϑ ( \frac{e \ddot{ρ}}{{ρ}^{2}} + 2 \dot{ρ} \frac{\dot{e} ρ - e \dot{ρ}}{{ρ}^{3}} ) , λ = ϑ \frac{e}{ρ} ,$$

D=2γ₃(tanh(λ)−tanh³(λ))\dot{λ}²;

The expression of \ddot{ε} is abbreviated as:

$$\ddot{ε} = E + G \ddot{e}$$

Where

$$E = \frac{{\dot{c}}^{2}}{2} ( \frac{- 1}{{( {γ}_{1} + c )}^{2}} - \frac{1}{{( {γ}_{2} - c )}^{2}} ) - \frac{1}{2} B D - \frac{1 - {tanh}^{2} ( λ )}{2} {γ}_{3} B C , G = \frac{1 - {tanh}^{2} ( λ )}{2 ρ} {γ}_{3} ϑ B ;$$

In this embodiment, by designing the constrained boundary of the tracking error through a prescribed performance function and introducing an improved error transformation function, the original tracking error constrained by the prescribed performance boundary is converted into an unconstrained error. This effectively solves the problem of strict restrictions on the initial tracking error in traditional prescribed performance control methods, endowing the control model with global applicability and enhancing its adaptability and robustness. In addition, the design of the error transformation function can rapidly increase the control input when the original error approaches the prescribed performance boundary, thereby ensuring the error quickly returns to the prescribed performance range, guaranteeing the transient performance of the system.

Further in step S3, the design of the fixed-time sliding mode surface combined with adaptive gain includes: defining a fixed-time sliding mode surface that includes control parameters and state variables; introducing a nonsingular terminal sliding mode function, and incorporating adaptive gain control into the derivative of the sliding mode surface to obtain the nonsingular terminal sliding mode surface.

The expression of the sliding mode surface s is as follows:

$$s = ε + {k}_{1} s i {g}^{{α}_{1}} ( ε ) + {k}_{2} s i {g}^{{α}_{2}} ( \dot{ε} )$$

$$\{ \begin{matrix}{α}_{1} = \frac{1}{2} + \frac{{σ}_{1}}{2} + sign ( 1 - \vert x \vert ) ( \frac{1}{2} - \frac{{σ}_{1}}{2} ) \\ {α}_{2} = {σ}_{2}^{sig n ( 1 - \vert x \vert )}\end{matrix}$$

Where sig^{y}(x)=|x|^{y} sign(x), σ₁>1 and 1<σ₂<2

The expression of the derivative of sliding mode surface is as follows:

$$\dot{s} = - {\hat{l}}_{1} sign ( s ) - {l}_{2} {sign}^{{β}_{1}} ( s ) - {l}_{3} {sign}^{{β}_{2}} ( s )$$

$${\dot{\hat{l}}}_{1} = {ϑ}_{1} \vert s \vert - {ϑ}_{2} {\hat{l}}_{1}$$

Where \hat{l}₁ is an adaptive control gain, l₂>0, l₃>0,

$${β}_{1} = {n}_{1}^{sig n ( \vert s \vert - 1 )} , {β}_{2} = {n}_{2}^{sig n ( 1 - \vert s \vert )} ,$$

n₁>1, 0<n₂<1, ϑ₁>0 and ϑ₂>0.

In this embodiment, by designing the sliding mode surface in fixed time combined with adaptive gain control, rapid convergence and precise control of the system state are achieved, and the singularity problem in traditional sliding mode control is overcome. Specifically, the fixed-time sliding mode surface is defined based on control parameters and state variables, ensuring that the system can reach a stable state within a fixed time. By introducing a nonsingular terminal function and embedding adaptive gain control into the derivative of the sliding mode surface, the robustness and responsiveness of the controller are further enhanced. The adaptive control gain can be adjusted in real time according to the system state: it rapidly increases the control input when the error is large to accelerate convergence and compensate for external disturbances; while reducing the control effort when the error is small, which avoids the overshoot problem of the control input and improves the stability of the system.

Further, in step S4, the process of constructing the control law includes: first, introducing the unconstrained error into the fixed-time sliding mode surface; then, based on the unconstrained error and combined with the position loop and attitude loop models, respectively constructing control expressions for the position tracking error and attitude tracking error to obtain the control law.

Specifically, according to the designed fixed-time nonsingular terminal sliding mode surface and control model, the new sliding mode surface is obtained as follows:

$$s = ε + {k}_{1} s i {g}^{{α}_{1}} ( ε ) + {k}_{2} s i {g}^{{α}_{2}} ( \dot{ε} )$$

By taking the derivative of both sides of the above equation and combining it with the designed derivative of the sliding mode surface, it can be obtained:

$$\ddot{ε} = - \frac{1}{{k}_{2} {α}_{2}} {\dot{ε}}^{1 - {α}_{1}} ( \dot{ε} + {k}_{1} {α}_{1} {\vert ε \vert}^{{α}_{1} - 1} \dot{ε} + {\hat{l}}_{1} sign ( s ) + {l}_{2} s i {g}^{{β}_{1}} ( s ) + {l}_{3} s i {g}^{{β}_{2}} ( s ) )$$

From the relationship between the original error and the transformed error, combined with the position loop model of the tiltrotor unmanned aerial vehicle, it can be obtained:

$$\ddot{ε} = E + G {\ddot{e}}_{P} = E + G ( {m}^{- 1} {u}_{P} + {d}_{F} - {\ddot{P}}_{d} )$$

Where e_{P}=P−P_{d} is the position tracking error, P is the current position, P_{d} is the desired position, then, the expression of the control law for the position loop, denoted as u_{P}, can be obtained as follows:

$${u}_{P} = m ( {\ddot{P}}_{d} - \frac{1}{{k}_{P 2} {a}_{P 2} G} {\dot{ε}}^{1 - {a}_{P 1}} ( \dot{ε} + {k}_{P 1} {a}_{P 1} {\vert ε \vert}^{{a}_{P 1} - 1} \dot{ε} + {\hat{l}}_{P 1} sign ( s ) + {l}_{P 2} s i {g}^{{β}_{P 1}} ( s ) + {l}_{P 3} s i {g}^{{β}_{P 2}} ( s ) ) - \frac{E}{G} - {d}_{F} )$$

Where the subscripts P1, P2, and P3 indicate that the parameters are those of the position loop controller;

The position loop controller consists of the equivalent control law and the reaching law based on the designed sliding mode surface. Among them, the reaching law ensures that the controlled state can reach the sliding mode surface, i.e., s=0, quickly within fixed time. Meanwhile, the adaptive gain estimates the upper bound of disturbances, which guarantees the stability of the control system and enhances its robustness.

Similarly, the relationship between the original error and the transformed error of the attitude loop of the tiltrotor unmanned aerial vehicle can be obtained as follows:

$${u}_{Ω} = I ( {I}^{- 1} ω \times I ω + {\ddot{Ω}}_{d} - \frac{1}{{k}_{Ω 2} {a}_{Ω 2} G} {\dot{ε}}^{1 - {a}_{Ω 1}} ( \dot{ε} + {k}_{Ω 1} {a}_{Ω 1} {\vert ε \vert}^{{a}_{Ω 1} - 1} \dot{ε} + {\hat{l}}_{Ω 1} sign ( s ) + {l}_{Ω 2} s i {g}^{{β}_{Ω 1}} ( s ) + {l}_{3} s i {g}^{{β}_{Ω 2}} ( s ) ) - \frac{E}{G} - {d}_{M} )$$

Where the subscripts Ω1, Ω2, and Ω3 indicate that the parameters are those of the attitude loop controller;

The complete flight control law of the tiltrotor unmanned aerial vehicle consists of a position loop controller and an attitude loop controller, with the designed position loop controller as the outer loop and the attitude loop controller as the inner loop. After inputting the desired trajectory, the position loop controller first computes the required virtual commands, and its output is used as the input of the attitude loop controller. Then, the output of the attitude loop controller is transmitted to the control allocation module to obtain the required rotor speed nᵢ, rotor tilt angle Φ, and deflection angles of the aerodynamic control surfaces, thereby realizing the flight control of the tiltrotor unmanned aerial vehicle;

In this embodiment, the construction of the control law achieves efficient and precise control of the tiltrotor unmanned aerial vehicle within fixed time, while significantly enhancing the adaptability and dynamic performance of the control system. Based on the design of unconstrained errors, the limitation of traditional control laws on initial errors is effectively broken through, ensuring the global stability of the controller. In addition, the introduction of the derivative of the sliding mode surface and the adaptive control gain enables the control law to dynamically adjust its parameters: it provides stronger control input when the error is large to accelerate convergence, and smoothly adjusts the input when the error is small, greatly improving the response speed and steady-state accuracy of the control system.

### Embodiment 2

This embodiment is further disclosed based on embodiment 1:

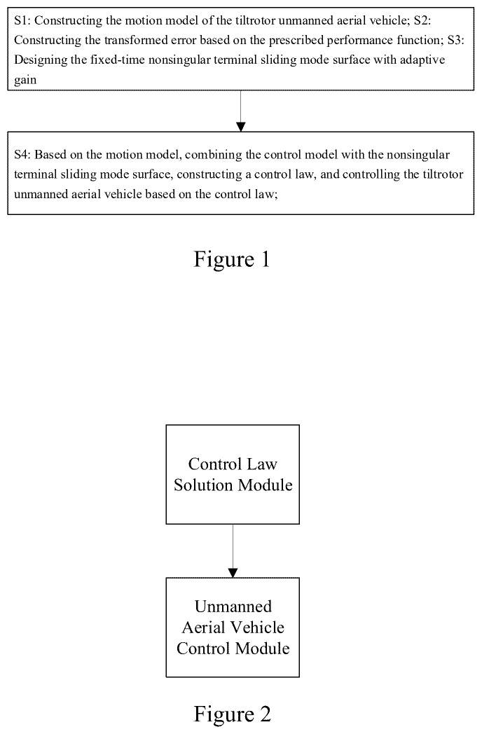

This embodiment discloses a fixed-time sliding mode control system for tiltrotor unmanned aerial vehicles with prescribed performance, which applies the fixed-time sliding mode control method for tiltrotor unmanned aerial vehicles with prescribed performance proposed in Embodiment 1. FIG. 2 is the architecture diagram of the fixed-time sliding mode control system for tiltrotor unmanned aerial vehicles with prescribed performance in this embodiment.

This embodiment proposes a fixed-time sliding mode control system for tiltrotor unmanned aerial vehicles with prescribed performance, including:
Control law solving module: It carries the motion model of the tiltrotor unmanned aerial vehicle, the control model based on prescribed performance, and the nonsingular terminal sliding mode surface. Based on the motion model, it integrates the control model with the nonsingular terminal sliding mode surface and generate the control law;
unmanned aerial vehicle control module: It controls the tiltrotor unmanned aerial vehicle based on the solved control law.

It can be understood that the system of this embodiment corresponds to the method of embodiment 1 mentioned above, and the optional features in embodiment 1 are also applicable to this embodiment, so they will not be repeated here.

### Embodiment 3

This embodiment discloses a computer device, comprising a memory and a processor. Computer-readable instructions are stored in the memory, wherein when the computer-readable instructions are executed by the processor, the processor is caused to perform the steps of the fixed-time sliding mode control method for tiltrotor unmanned aerial vehicles with prescribed performance proposed in embodiment 1.

### Embodiment 4

This embodiment discloses a storage medium on which readable instructions are stored. When the readable instructions are executed by a processor, the steps of the fixed-time sliding mode control method for tiltrotor unmanned aerial vehicles with prescribed performance proposed in embodiment 1 are implemented.

### Embodiment 5

Based on embodiments 1 to 4, this embodiment conducts simulation for flight control of the tiltrotor unmanned aerial vehicle.

The simulation lasts for 15 s with a sampling frequency of 1000 Hz. The main parameters of the tiltrotor unmanned aerial vehicle are as follows: unmanned aerial vehicle's mass m=6 kg, moment of inertia I=diag{0.459,0.446,1.609}kg·m², wing span b=2.1 m, wing area S=0.54 m², mean aerodynamic chord c̅=0.283 m and distance from the coordinate axis of body frame to origin of each rotor l=0.54 m;

The initial position is [1.5, −2,0]^{T} m, the initial attitude is [6, −10,4]^{T} deg, the desired trajectory is [2 sin(0.1πt)+sin(0.3 πt), sin(0.1πt), −0.25t−0.5]^{T} m, the desired attitude is [15 sin(0.75πt), 15 sin(0.75πt), 0.2t−2]^{T} deg. The lumped disturbance in position loop and attitude loop is dᵢ=sin(πt)(i=F, M).

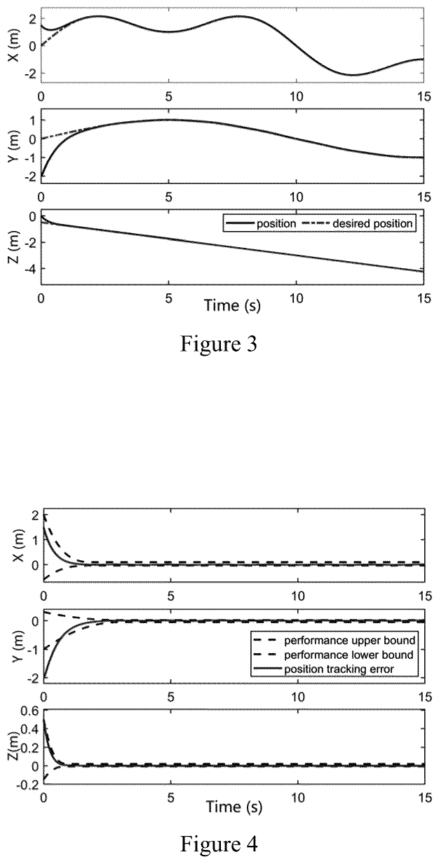

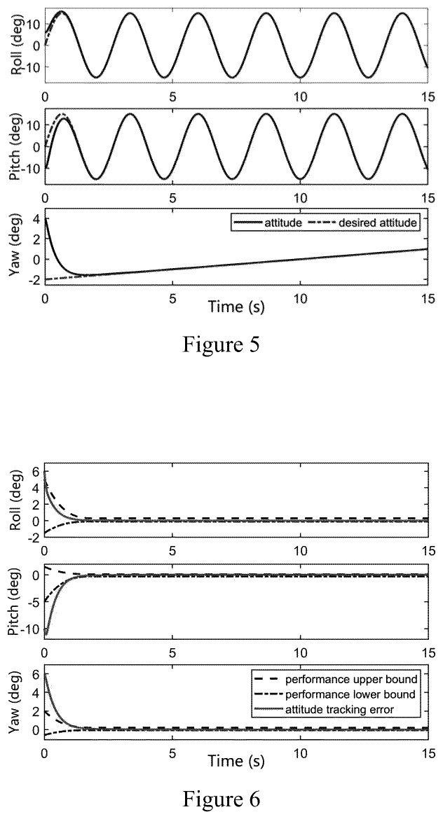

Then, the graphs of the results of trajectory tracking, tracking errors, attitude tracking, rotor speeds and control surface angles are depicted in FIGS. 3, 4, 5 and 6.

In summary, embodiments of the present invention provide a fixed-time sliding mode control system for tiltrotor unmanned aerial vehicles with prescribed performance. This includes: establishing a position loop and attitude loop models of the tiltrotor unmanned aerial vehicle; constructing a transformed error based on the prescribed performance function; designing the fixed-time nonsingular terminal sliding mode surface with adaptive gain; based on the motion model and the nonsingular terminal sliding mode surface, a control law is constructed, and the tiltrotor unmanned aerial vehicle is controlled based on the control law. The controller achieves fast fixed-time convergence without the need to introduce additional auxiliary functions to avoid the singularity problem, and ensures the robustness of the tiltrotor unmanned aerial vehicle's flight control under disturbances. Meanwhile, it eliminates the restriction on initial requirements and realizes global prescribed performance control.

Obviously, the above embodiments of the present invention are merely embodiments for the purpose of clearly illustrating the present invention, and are not intended to be a limitation of the embodiments of the present invention. For those of ordinary skill in the professional filed, other variations or changes in different forms may be made on the basis of the above description. It is neither necessary nor possible to exhaust all the embodiments herein. Any modifications, equivalent substitutions and improvements made within the spirit and principles of the present invention shall be included in the scope of protection of the claims of the present invention.

1. A fixed-time sliding mode control method for a tiltrotor unmanned aerial vehicle with prescribed performance, characterized by comprising the following steps:
constructing a motion model of the tiltrotor unmanned aerial vehicle; constructing a transformed error based on the prescribed performance function; designing a fixed-time nonsingular terminal sliding mode surface with adaptive gain;
based on the motion model, combining a control model with the nonsingular terminal sliding mode surface, constructing a control law, and controlling the tiltrotor unmanned aerial vehicle based on the control law;
wherein the step of constructing the transformed error based on the prescribed performance function includes:
designing tracking error and its boundary based on the prescribed performance function;
designing an error transformation function to convert the tracking error into an unconstrained error that is not restricted by the initial boundary of the prescribed performance function;
constructing the control model based on the unconstrained error;
wherein the error transformation function is expressed as follows:
$$Ψ ( ε ) = \frac{{γ}_{2} exp ( ε ) - {γ}_{1} exp ( - ε )}{exp ( ε ) + exp ( - ε )} = {γ}_{3} tanh ( ϑ \frac{e ( t )}{ρ ( t )} )$$
$${γ}_{1} = \frac{1}{2} ( δ - 1 ) sign ( e ( 0 ) ) + \frac{1}{2} ( δ + 1 )$$
$${γ}_{2} = \frac{1}{2} ( 1 - δ ) sign ( e ( 0 ) ) + \frac{1}{2} ( δ + 1 )$$
$${γ}_{3} = \{ \begin{matrix}{γ}_{2} , & e ( t ) \geq 0 \\ {γ}_{1} , & e ( t ) < 0\end{matrix}$$
where sign(⋅) is a signum function, 0<δ≤1, e(0) is an initial tracking error; E is a transformed error, P is a constant greater than 1, e(t) is the tracking error, ρ(t) is the fixed-time prescribed performance function;
wherein the step of designing the fixed-time sliding mode surface combined with adaptive gain includes:
defining a fixed-time sliding mode surface containing control parameters and state variables;
introducing a nonsingular terminal sliding mode function, and introducing adaptive gain control into the derivative of the sliding mode surface to obtain a nonsingular terminal sliding mode surface; the expression of the sliding mode surface s is as follows:
$$s = ε + {k}_{1} s i {g}^{{α}_{1}} ( ε ) + {k}_{2} s i {g}^{{α}_{2}} ( \dot{ε} )$$
$$\{ \begin{matrix}{α}_{1} = \frac{1}{2} + \frac{{σ}_{1}}{2} + sign ( 1 - \vert x \vert ) ( \frac{1}{2} - \frac{{σ}_{1}}{2} ) \\ {α}_{2} = {σ}_{2}^{s i g n ( 1 - \vert x \vert )}\end{matrix}$$
$$si {g}^{y} ( x ) = {\vert x \vert}^{y} sign ( x )$$
where k₁>0, k₂>0, α₁ and α₂ are control parameters to be designed;
wherein the expression for the derivative of the sliding mode surface is as follows:
$$\dot{s} = - {\hat{l}}_{1} sign ( s ) - {l}_{2} {sign}^{{β}_{1}} ( s ) - {l}_{3} {sign}^{{β}_{2}} ( s )$$
$${\dot{\hat{l}}}_{1} = {ϑ}_{1} \vert s \vert - {ϑ}_{2} {\hat{l}}_{1}$$
where \hat{l}₁ is an adaptive control gain, l₂>0, l₃>0,
$${β}_{1} = {n}_{1}^{si gn ( \vert s \vert - 1 )} , {β}_{2} = {n}_{2}^{s i g n ( 1 - \vert s \vert )} ,$$
n₁>1, 0<n₂<1, ϑ₁>0 and ϑ₂>0.

2. The fixed-time sliding mode control method for a tiltrotor unmanned aerial vehicle with prescribed performance as claimed in claim 1, characterized in that the step of constructing the mathematical model of the tiltrotor unmanned aerial vehicle comprises:
constructing the position loop model and attitude loop model of the unmanned aerial vehicle; and obtaining the six-degree-of-freedom motion equation based on the position loop model and the attitude loop model.

3. The fixed-time sliding mode control method for a tiltrotor unmanned aerial vehicle with prescribed performance as claimed in claim 2, characterized in that the step of constructing the position loop model of the unmanned aerial vehicle comprises:
correlating the velocity in the body coordinate system with the position in the ground coordinate system through a transformation matrix, model the velocity and acceleration of the unmanned aerial vehicle, and model the rotor thrust, aerodynamic force, and gravity in the acceleration to obtain the position loop model of the unmanned aerial vehicle, whose expression is as follows:
$$\dot{P} = [ \begin{matrix}{\dot{x}}_{e} \\ {\dot{y}}_{e} \\ H\end{matrix} ] = ν = [ \begin{matrix}{v}_{x} \\ {v}_{y} \\ {v}_{z}\end{matrix} ] = {R}_{b}^{e} [ \begin{matrix}u \\ v \\ w\end{matrix} ]$$
$$\ddot{P} = \dot{ν} = \frac{1}{m} ( {F}_{p} + {F}_{a} + {F}_{g} ) + {d}_{F}$$
$${F}_{p} = {\sum }_{i = 1}^{4} {R}_{b}^{e} {R}_{r i}^{b} {T}_{i} = {R}_{b}^{e} [ \begin{matrix}{T}_{1} sin Φ + {T}_{3} sin Φ \\ 0 \\ - {T}_{1} cos Φ - {T}_{2} - {T}_{3} cos Φ - {T}_{4}\end{matrix} ]$$
$${F}_{a} = [ \begin{matrix}- D \\ Y \\ - L\end{matrix} ] = \overline{q} S [ \begin{matrix}- {C}_{D} \\ {C}_{Y} \\ - {C}_{L}\end{matrix} ]$$
$${F}_{g} = [ \begin{matrix}0 \\ 0 \\ 1\end{matrix} ] mg$$
where P=[xₑ, yₑ, H]^{T} is a position vector of the tiltrotor unmanned aerial vehicle in the ground frame; v=[vₓ, v_{y}, v_{z}] is a velocity vector of the tiltrotor unmanned aerial vehicle in the ground frame;
$${R}_{b}^{e}$$
is a transformation matrix from the body frame to the ground frame, [u, v, w]^{T} is the velocity vector of the tiltrotor unmanned aerial vehicle in the body frame; \dot{v} is the acceleration; m is a mass of the tiltrotor unmanned aerial vehicle, d_{F} is the total disturbance of the position loop, Fₚ is the force generated by the rotors, Fₐ is the aerodynamic force generated by the wings and fuselage, F_{g} is the gravity of the tiltrotor unmanned aerial vehicle;
$${R}_{r i}^{b}$$
is the transformation matrix from the rotor frame to the body coordinate system, Tᵢ (i=1, 2, 3, 4) is the thrust generated by each rotor, [D, Y, L]^{T} are the drag force, side force, and lift force acting on the tiltrotor unmanned aerial vehicle respectively; q̅ is the dynamic pressure, σ is the air density, [C_{D}, C_{Y}, C_{L}]^{T} are the drag coefficient, side force coefficient, and lift coefficient respectively; S is the projected area of the tiltrotor unmanned aerial vehicle, g is the gravitational acceleration; D is the rotor tilt angle.

4. The fixed-time sliding mode control method for a tiltrotor unmanned aerial vehicle with prescribed performance as claimed in claim 2, characterized in that the step of constructing the attitude loop model of the unmanned aerial vehicle comprises:
correlating the attitude angular velocity of the tiltrotor unmanned aerial vehicle with the differential of the attitude angle through a transformation matrix, and construct the attitude angle dynamic equation; decompose the total torque of the tiltrotor unmanned aerial vehicle, model the torque generated by the rotors and the aerodynamic torque of the wings or fuselage, and obtain the attitude loop model of the unmanned aerial vehicle, whose expression is as follows:
$$\dot{Ω} = [ \begin{matrix}\dot{ϕ} \\ \dot{θ} \\ \dot{ψ}\end{matrix} ] = [ \begin{matrix}1 & sin ϕ tan θ & cos ϕ tan θ \\ 0 & cos ϕ & - sin ϕ \\ 0 & sin ϕ / cos θ & cos ϕ / cos θ\end{matrix} ] = {R}_{w}^{Ω} ω$$
$${M}_{p} = [ \begin{matrix}{lT}_{1} cos Φ - {lT}_{2} - {lT}_{3} cos Φ + {lT}_{4} + {τ}_{1} sin Φ - {τ}_{3} sin Φ \\ - {lT}_{1} cos Φ + {lT}_{2} - {lT}_{3} cos Φ + {lT}_{4} \\ {lT}_{1} sin Φ - {lT}_{3} sin Φ + - {τ}_{1} sin Φ - {τ}_{2} + {τ}_{3} cos Φ + {τ}_{4}\end{matrix} ]$$
$${M}_{a} = \overline{q} S [ \begin{matrix}{l}_{w} {C}_{l} \\ \overline{c} {C}_{m} \\ {l}_{w} {C}_{n}\end{matrix} ]$$
$$\ddot{Ω} = \dot{ω} = - {I}^{- 1} ω \times I ω + {I}^{- 1} M + {d}_{M}$$
where, Ω=[φ, θ, ψ]^{T} is the attitude angle of the tiltrotor unmanned aerial vehicle; ω=[p, q, r]^{T} is the attitude angular velocity;
$${R}_{w}^{Ω}$$
is the transformation matrix from the attitude angular velocity to the differential of the attitude angle; l is the distance between the rotors;
$${τ}_{i} = {k}_{P} {n}_{i}^{2} ( i = 1 , 2 , 3 , 4 )$$
is the reaction generated by the rotors; k_{P} is the reaction coefficient of the rotors; nᵢ is the rotational speed of each rotor; l_{w} is the wingspan of the tiltrotor unmanned aerial vehicle; C is the mean aerodynamic chord; [Cₗ, Cₘ, Cₙ]^{T} are the roll moment, pitch moment, and yaw moment respectively; (is the rotor tilt angle; I=[Iₓ, I_{y}, I_{z}] is the moment of inertia; d_{M} is the total disturbance of the attitude loop.

5. The fixed-time sliding mode control method for a tiltrotor unmanned aerial vehicle with prescribed performance as claimed in claim 4, characterized in that the step of constructing the control law comprises:
introducing the unconstrained error into the fixed-time sliding mode surface; and
based on the unconstrained error, combining the position loop and attitude loop models to respectively construct control expressions for the position error and attitude error, so as to obtain the control law.

6. A fixed-time sliding mode control system for a tiltrotor unmanned aerial vehicle with prescribed performance, applied to the fixed-time sliding mode control method for a tiltrotor unmanned aerial vehicle with prescribed performance as described in claim 1, characterized in that the system comprises:
a control law solution module which carries the motion model of the tiltrotor unmanned aerial vehicle, the control model based on prescribed performance, and the nonsingular terminal sliding mode surface; wherein the control law solution module is configured to combine the control model with the nonsingular terminal sliding mode surface and generate the control law based on the motion model;
an unmanned aerial vehicle control module configured to control the tiltrotor unmanned aerial vehicle based on the control law.

7. An electronic device, comprising a memory, a processor, and a computer program stored in the memory and executable by the processor, characterized in that the processor is configured to execute the computer program to implement the fixed-time sliding mode control method for a tiltrotor unmanned aerial vehicle with prescribed performance as described in claim 1.

8. A computer-readable storage medium, on which a computer program is stored, characterized in that the computer program is executed by a processor to implement the fixed-time sliding mode control method for a tiltrotor unmanned aerial vehicle with prescribed performance as described in claim 1.
